(19) United States
(12) Patent Application Publication
(10) Pub. No.: US 2016/0095293 A1
(43) Pub. Date: Apr. 7, 2016

(54) HORSE GROOMING TOOL

(71) Applicants: Sarah Owen, Santa Ynez, CA (US); Dennis Domingos, Buellton, CA (US)

(72) Inventors: Sarah Owen, Santa Ynez, CA (US); Dennis Domingos, Buellton, CA (US)

(21) Appl. No.: 14/507,725

(22) Filed: Oct. 6, 2014

(51) Int. Cl. A01K 13/00

(52) U.S. Cl. CPC A01K 13/001

(57) ABSTRACT

A horse grooming tool employs a substantially rectangular body having a top surface, a lower surface, a first end, a second end and two sides. The body is composed of vulcanized polymer rubber.

### BACKGROUND INFORMATION

1. Field

Embodiments of the disclosure relate generally to the field of equine care and more particularly to a tool for grooming horses employing shaping and a compacted adhered rubber composition in a hand held body for hair and dust removal.

2. Background

Grooming of horses is a time consuming and labor intensive task. However, enhanced health benefits of regular grooming and, for show and general riding purposes, a very clean coat on the horse for appearance are highly desirable. Most equine grooming is accomplished with a curry comb and/or dandy brush with repeated strokes to thoroughly clean dust and shedding hair from the horse. The entire horse must be groomed including the body, neck, head and legs. Uneven surfaces, particularly around tendons and bony protrusions in the legs, cannons, hocks and pasterns, are typically very sensitive areas of the horse and grooming must be accomplished carefully.

Curry combs, whether plastic or metal, tend to be very stiff and many horses find their use uncomfortable. Such devices may be particularly unsuitable for the sensitive legs, cannons, hocks and pasterns. Further, while curry combs typically break up dirt and shedding hair in the horses coat, brushing with a fairly stiff brush is typically still be required to fully remove detritus by a curry comb, or as a single use tool without the use of a curry comb, and the stiff bristles of such brushes may also create discomfort for certain horses.

It is therefore desirable to provide a grooming tool which does not create discomfort for even sensitive horses and allows cleaning of sensitive body areas as well as overall body grooming

### SUMMARY

Exemplary embodiments provide a horse grooming tool with a body having a top surface, a lower surface, a first end, a second end and two sides. The body is composed of vulcanized polymer rubber.

In one embodiment the body is substantially rectangular and incorporates edges between the top surface and sides and lower surface and sides, which are substantially perpendicular at the edges.

An additional feature of fillets between the first end and one or both sides is also disclosed.

The features, functions, and advantages that have been discussed can be achieved independently in various embodiments of the present invention or may be combined in yet other embodiments further details of which can be seen with reference to the following description and drawings

### BRIEF DESCRIPTION OF THE DRAWINGS

FIG. 1 is a pictorial view of a first embodiment of the grooming tool;

FIG. 2 is a top view of the embodiment;

FIG. 3 is a first end view of the embodiment;

FIG. 4 is second end view of the embodiment; and,

FIG. 5 is a bottom view of the embodiment.

### DETAILED DESCRIPTION

The embodiments described herein disclose a grooming tool sized to fit the groomer's hand and having a body composed of finely ground, compacted and adhered rubber. While usable on all parts of the horse including hooves, for hair removal as well as cleaning of tack and the scrapping of sweat and water, the body is also shaped for contact with delicate body surfaces and may incorporate at least one side with a textured surface. A hole in the body may be provided for attachment of a wrist lanyard to enhance usability of the tool.

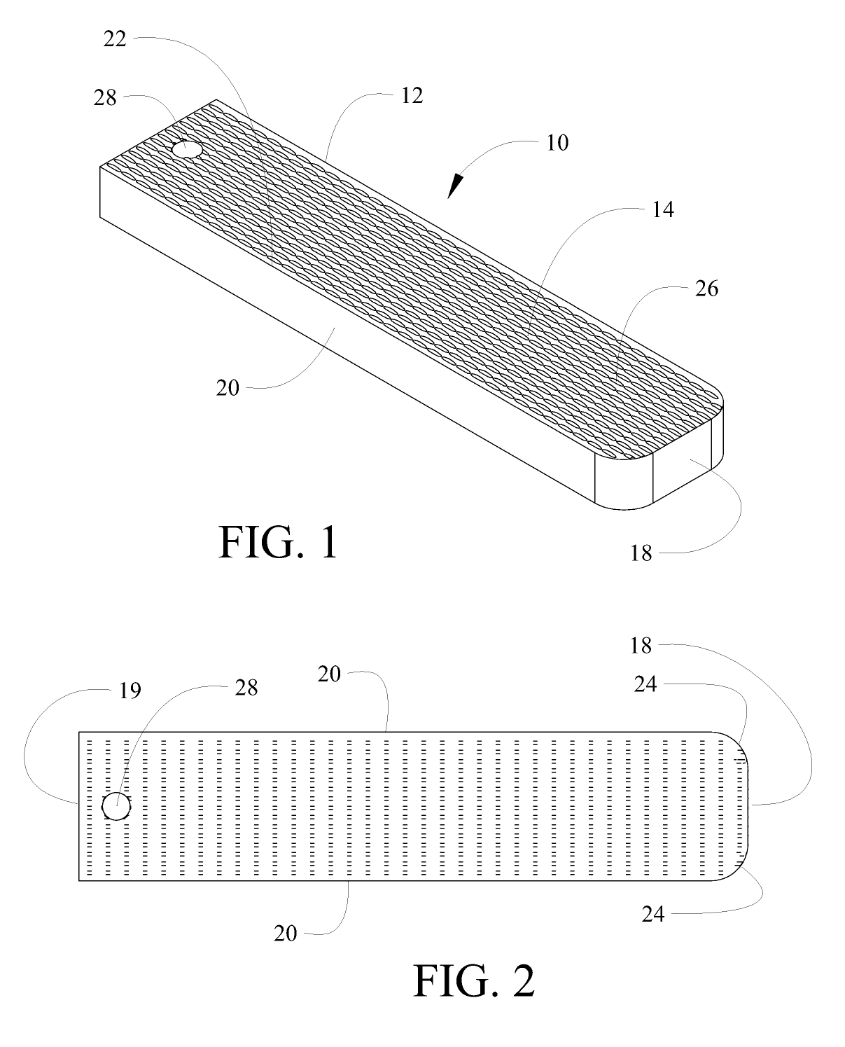

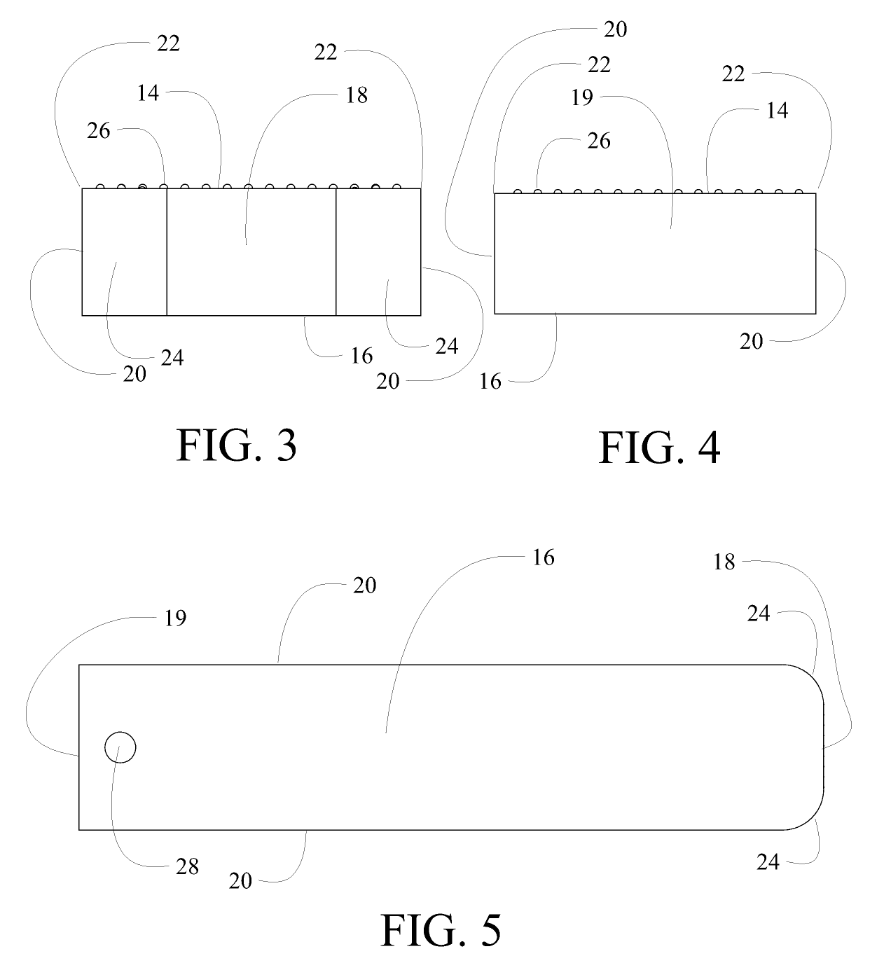

Referring to the drawings, FIGS. 1 through 5 show an exemplary embodiment of the horse grooming tool 10. The tool has a substantially rectangular body 12 with a top surface 14 and bottom surface 16 which act as primary cleaning surfaces. A first end 18 and a second end 19 and side walls 20 provide alternative cleaning surfaces. A first example of the grooming tool is approximately 2″ in width and 9″ in length with a thickness of approximately ¾″. An alternative example of the tool for use by groomers with smaller hands or to be “pocket sized” is approximately 2 ⅜″ in width and 4 ¾″ in length with a thickness of approximately ⅜″. Sizing of the tool between these two sizes to accommodate specific needs may be accomplished in alternative embodiments.

Top surface 14 and bottom surface 16 provide planar surfaces for broad cleaning strokes on the body and neck of the horse. Sides 20 and associated edges 22 between the sides and top and bottom surfaces may be employed for enhanced shedding with the tool. For the embodiment shown, the sides and top and bottom surfaces are substantially perpendicular at edges 22. However the resilient material of the tool avoids discomfort for the horse. Similarly , the first end 18 and second end 19 may be employed for grooming in portions of the body having close curves or grooves such as the cannons, hocks and pasterns. Fillets 24 may be present between one or both of the sides 20 and the first end 18 to enhance the contact of the tool in such areas where a sharper edge may not be desirable. Similarly, fillets may be employed between the sides 20 and second end 19, if desired.

As seen in FIGS. 1, 2, 3 and 4, the top surface 14 of the tool 10 may be textured to enhance the effectiveness of the surface in loosening dirt and shedding hair. Low profile elliptical or diamond shaped protrusions 26 arranged in an array to create the texture have been demonstrated on example implementations of the tool. While a symmetrical array is shown, an asymmetrical array may be used in alternative embodiments. For the example tool the bottom surface 16 is untextured as shown in FIG. 5 to provide an alternative cleaning effect. However in alternative embodiments, both surfaces may be textured.

The body 12 of the tool is formed from a vulcanized rubber polymer. For the example embodiments the composition constitutes fine ground rubber which has been compressed and adhered using latex adhesive, sulfur and process oil. The composition includes as percent by weight 93% fine ground rubber, as from recycled rubber tires, 2.4% Polymer, 1.9% Sulfur and 2.8% process oil (solvent refined and hydro treated). Trace amounts of 1, 3 Butadiene and Styrene may be present. The composition provides a specific gravity of approximately 1.12 with a density of 70 lbs/cuft. A Shore A durometer value of between 60 and 65 is desirable with a value of 63 being used for the example embodiment.

As seen in FIGS. 1, 2 and 5, an aperture 28 may be provided through the body 12 proximate the second end 19 to allow a lanyard (not shown) to be passed through and knotted. The lanyard can then be placed around the wrist of the groomer to allow the tool to be retained for use without directly grasping the tool with the hand thereby freeing the hand.

For grooming a horse, the body 12 of the tool is grasped in the hand and either the flat of the top or bottom surface, the sides, or the first or second end is rubbed against the portion of the horse on which grooming is desired. As previously described, the body 12 may be angled to engage one of the edges 22 with the coat of the horse. The body 12 is then moved in a smooth stroke to clean dirt and hair from the horse's coat. The fillets 24 may be inserted into grooves or tight curves on the body of the horse for cleaning.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A horse grooming tool comprising:
a body having
a top surface, a lower surface, a first end, a second end and two sides,
said body composed of vulcanized polymer rubber.

2. The horse grooming tool as defined in claim 1 wherein the body is substantially rectangular and incorporates edges between the top surface and sides and lower surface and sides, which are substantially perpendicular at the edges.

3. The horse grooming tool as defined in claim 1 wherein the top surface is textured.

4. The horse grooming tool as defined in claim 3 wherein the texture is an array of low profile protrusions selected from a set of elliptical or diamond shaped protrusions.

5. The horse grooming tool as defined in claim 4 wherein the array is symmetrical.

6. The horse grooming tool as defined in claim 2 wherein at least one fillet is provided between the first end an one side.

7. The horse grooming tool as defined in claim 6 wherein a fillet is provided between the first and each side.

8. The horse grooming tool as defined in claim 1 wherein the vulcanized rubber is fine ground rubber compressed and adhered using latex adhesive, sulfur and process oil.

9. The horse grooming tool as defined in claim 1 wherein the vulcanized rubber includes as percent by weight 93% fine ground rubber, 2.4% Polymer, 1.9% Sulfur and 2.8% process oil.

10. The horse grooming tool as defined in claim 1 wherein the vulcanized rubber has a Shore A durometer value of between 60 and 65.

11. The horse grooming tool as defined in claim 2 wherein the body is between 2″ and 2 ⅜″ wide and between 4 ¾″ and 9″ long.
